(19) United States
(12) Patent Application Publication
(10) Pub. No.: US 2015/0161615 A1
(43) Pub. Date: Jun. 11, 2015

(54) CHAT BASED COLLABORATION TOOL AND CORRESPONDING METHOD

(71) Applicant: Infosys Limited, Bangalore (IN)

(72) Inventors: Narayan Balasubramanian, Chennai (IN); Subha Mahesh, Chennai (IN); Nandavilasini Govindasamy, Chennai (IN); Gaurav Deshmukh, Chennai (IN)

(73) Assignee: Infosys Limited, Bangalore (IN)

(21) Appl. No.: 14/099,620

(22) Filed: Dec. 6, 2013

(51) Int. Cl. G06Q 30/00; G06Q 10/06; H04L 29/06

(52) U.S. Cl. CPC G06Q 30/016; H04L 65/403; G06Q 10/063112

(57) ABSTRACT

A chat collaboration tool is disclosed. In particular, a network enabled chat session is established between a customer and an agent of an entity. The customer has a customer issue that is to be resolved by a specialist of the entity and not the agent via the chat session. A specialist query is generated based at least on information of the customer issue, wherein the specialist query includes one or more parameters specific at least to the customer issue. At least one available specialist capable of handling the customer issue is identified based on satisfied matches between attributes available specialists and corresponding parameters of the specialist query. The available specialist(s) are displayed on the agent's user interface wherein the agent is able to select an available specialist. A chat session is then established between the customer and the available specialist upon receiving the agent selection.

### FIELD

The present disclosure relates to a chat based collaboration tool and corresponding method.

### BACKGROUND

In today's e-business world, it is common for a company to interact with its customers using chat functionality. In particular, a customer who desires to interact with a customer representative at a desired company may utilize available chat implementations to communicate with the customer representative online by text to address an issue (e.g. answer a question, resolve a problem). Typically, a customer representative agent (also referred to as “agent”) initially handles the chat session initiation with the customer, greets the customer, and tries to address the customer's issue. However, if the customer's issue is directed to an area outside the agent's knowledge or expertise, the agent must defer the customer's issue to a specialist who is trained or has expertise to be able to address the customer's issue.

Existing chat implementations have significant limitations to handle the scenarios where the agent will need to defer the customer's issue to a competent specialist. For instance, the agent may not know which specialist to contact for a particular customer issue. In another instance, the agent may know which specialist to direct the customer's issue to, but may be notified that the specialist is not currently working, thereby leaving the agent at a loss as to who to route the customer to.

What is needed is a chat collaboration tool and associated method which overcomes these disadvantages.

### SUMMARY

In an aspect, a method of utilizing a chat collaboration tool is disclosed. The method includes establishing, using a network interface, a network enabled chat session between a customer and an agent of an entity. The customer has a customer issue that is to be resolved by a specialist of the entity and not the agent. The method includes generating, using a processor, a specialist query based at least on information of the customer issue, wherein the specialist query includes one or more parameters specific at least to the customer issue. The method includes identifying, using the processor, at least one available specialist capable of handling the customer issue based on a match between an attribute of the available specialist and a corresponding parameter of the specialist query. The method includes displaying the at least one available specialist on a user interface of the agent, wherein the displayed at least one available specialist is configured to be selected by the agent. The method includes routing the chat session from the agent to the available specialist upon receiving a selection from the agent via the user interface.

In an aspect, a computer readable medium is disclosed. The medium has stored thereon instructions for providing a chat collaboration tool. The medium comprises computer executable code which, when executed by at least one processor, causes the processor to establish, using a network interface, a network enabled chat session between a customer and an agent of an entity. The customer has a customer issue that is to be resolved by a specialist of the entity and not the agent. A specialist query is generated based at least on information of the customer issue, wherein the specialist query includes one or more parameters specific at least to the customer issue. At least one available specialist capable of handling the customer issue is identified based on a match between an attribute of the available specialist and a corresponding parameter of the specialist query. At least one available specialist is displayed on a user interface of the agent, wherein the displayed at least one available specialist is configured to be selected by the agent. A chat session is routed between the customer and the available specialist upon receiving a selection from the agent via the user interface.

In an aspect, a computing device is disclosed. The computing device includes a network interface configured to establish a network enabled chat session between a customer and an agent of an entity, wherein the customer has a customer issue that is to be resolved by a specialist of the entity and not the agent. The computing device includes a memory having stored thereon instructions for providing a chat collaboration tool, comprising processor executable code. The computing device includes a processor coupled to the network interface and the memory. The processor is configured to execute the processor executable code, the code causing the processor to generate a specialist query based at least on information of the customer issue, wherein the specialist query includes one or more parameters specific at least to the customer issue. The processor is configured to identify at least one available specialist capable of handling the customer issue based on a match between an attribute of the available specialist and a corresponding parameter of the specialist query. The processor is configured to display the at least one available specialist on a user interface of the agent, wherein the displayed at least one available specialist is configured to be selected by the agent. The processor is configured to establish, via the network interface, a chat session between the customer and the available specialist upon receiving a selection from the agent via the user interface.

In one or more above aspects, prior to identifying at least one available specialist, a database containing information of a plurality of specialists is accessed, wherein each specialist includes associated attribute information. A first parameter is selected of the specialist query and a first plurality of specialists having a corresponding first attribute that satisfies the first parameter is identified. A second parameter is selected of the specialist query and a second plurality of specialists having a corresponding second attribute that satisfies the second parameter is identified. The at least one available specialist is selected, wherein the at least one available specialist has the first and second attributes.

In one or more above aspects, the at least one available specialist further comprises a plurality of available specialists. A first score for a first available specialist is calculated. A second score for a second available specialist is calculated, wherein the first score and second score are based on the number of specialists' attributes that satisfy the parameters of the specialist query. The first and second available specialists are organized and displayed to the agent in an order based on their calculated scores.

In one or more above aspects, the first parameter of the specialist query is a current time of the chat session and the first attribute of a particular specialist indicates that the specialist is available to handle the chat session at the current time.

In one or more above aspects, at least one available specialist further comprises a plurality of available specialists. A request to a first available specialist is sent to handle the customer's issue, wherein the chat session remains between the customer and the agent. A denial is received from the first available specialist to handle the customer's issue. A request to a second available specialist is then sent to handle the customer's issue, wherein the chat session remains between the customer and the agent. An acceptance is then received from the second available specialist, wherein the chat session is established between the customer and the second available specialist and the chat session is no longer between the customer and the agent.

### BRIEF DESCRIPTION OF THE DRAWINGS

FIG. 1 illustrates a diagram of an example system environment that utilizes a chat collaboration tool and associated method in accordance with an aspect of the present disclosure;

FIG. 2A illustrates a block diagram of a client network device implementing at least a portion of the chat collaboration tool in accordance with an aspect of the present disclosure;

FIG. 2B illustrate a block diagram of a server network device implementing at least a portion of the chat collaboration tool in accordance with an aspect of the present disclosure;

FIG. 3 illustrates an example block diagram representing the chat session initiation between an agent and a customer and the dynamic routing implementation using the chat collaboration tool between the customer and one or more specialists in accordance with an aspect of the present disclosure; and

FIG. 4 illustrates an example flow chart diagram depicting at least a portion of processes performed by the chat collaboration tool in accordance with an aspect of the present disclosure.

### DETAILED DESCRIPTION

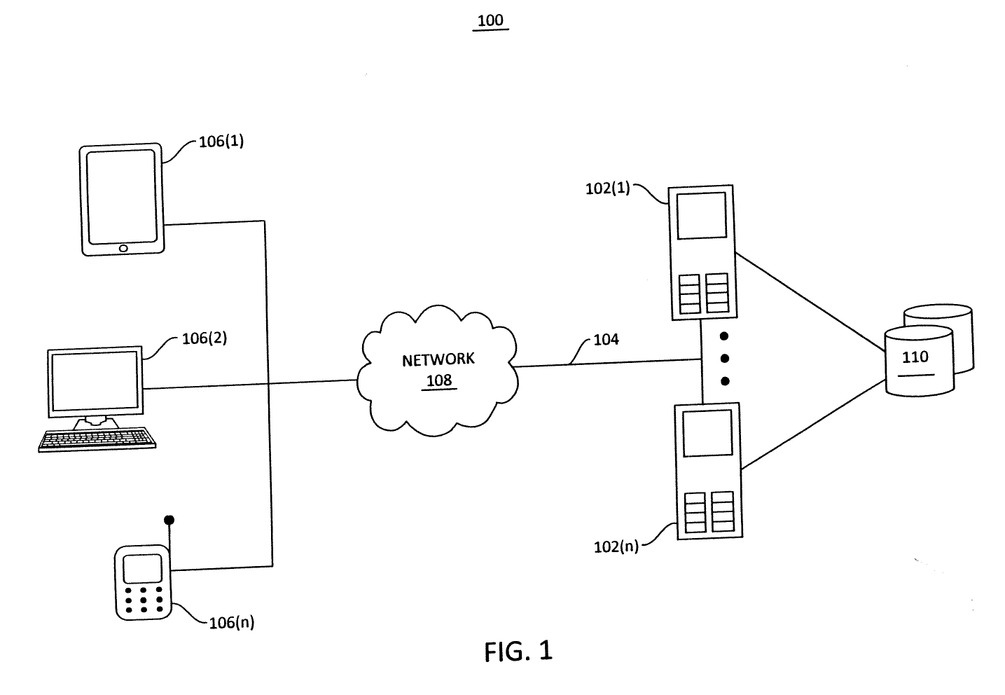

FIG. 1 illustrates a diagram of an example system environment that implements and executes a chat collaboration tool and method in accordance with an aspect of the present disclosure. In particular, the example system environment 100 includes a plurality of network devices such as one or more servers 102(1)-102(n) and one or more client devices 106(1)-106(n), although the environment 100 could include other numbers and types of devices in other arrangements. It should be noted that the term “network devices” can be referred to as encompassing one or more client devices, one or more servers, virtual machines, cloud computing devices and/or other components in the system 100.

The servers 102(1)-102(n) are connected to a local area network (LAN) 104 and the client devices 106(1)-106(n) are connected to a wide area network 108, whereby the one or more client devices 106(1)-106(n) communicate with the one or more servers 102(1)-102(n) via the wide area network 108 and LAN 104. The servers 102(1)-102(n) comprise one or more network devices or machines capable of operating one or more Web-based and/or non Web-based applications that may be accessed by other network devices (e.g. client devices, other servers) in the network 108. One or more servers may be front end Web servers, application servers, and/or database servers. Such data includes, but is not limited to Web page(s), image(s) of physical objects, user account information, and any other objects and information. It should be noted that the servers 102(1)-102(n) may perform other tasks and provide other types of resources.

One or more servers 102 may comprise a cluster of a plurality of servers which are managed by a network traffic management device (e.g. firewall, load balancer, web accelerator), gateway device, router, hub and the like. In an aspect, one or more servers 102(1)-102(n) may implement a version of Microsoft IIS servers, RADIUS servers and/or Apache® servers, although other types of servers may be used and other types of applications may be available the on servers 102(1)-102(n). It should be noted that although the client device and/or server may be referred to herein in the plural, it is contemplated that only one client device and/or one server may be considered without being limiting to the language used herein. It should be understood that the particular configuration of the system 100 shown in FIG. 1 are provided for exemplary purposes only and is thus not limiting.

Client devices 106(1)-106(n) comprise computing devices capable of connecting to other computing devices, such as the servers 102(1)-102(n). Such connections are performed over wired and/or wireless networks, such as network 108, to send and receive data, such as for Web-based and non Web-based requests, receiving responses to requests and/or performing other tasks, in accordance with the novel processes described herein. Non-limiting and non-exhausting examples of such client devices 106(1)-106(n) include, but are not limited to, personal computers (e.g., desktops, laptops), mobile and/or smart phones, kiosks, ATMs, tablet devices, PDAs and the like.

In an example, client devices 106(1)-106(n) may be configured to run a Web browser or other software module that provides a user interface for human users to interact with and access the chat collaboration tool 220. In an example, the user can use the client device 106 to request resources and/or information, as well as submit instructions over the network 108 to the one or more servers 102(1)-102(n) via Web-based or non Web-based applications. One or more Web-based or non Web-based applications may accordingly run on the servers 102(1)-102(n) that provide the requested data to the client device 106(1)-106(n) and/or perform the requested instructions on behalf of the user. In an example, the client device 106 may be a smart phone, tablet, or smart television in which the client devices 106(1)-106(n) communicate with the servers 102(1)-102(n) via a mobile application (i.e. “mobile app”).

Network 108 comprises a publicly accessible network, such as the Internet, which handles communication between the client devices 106(1)-106(n) and the servers 102(1)-102(n). However, it is contemplated that the network 108 may comprise other types of private and public networks. Communications, such as requests from client devices 106(1)-106(n) and responses from servers 102(1)-102(n), preferably take place over the network 108 according to standard network protocols, such as the HTTP, UDP, and TCP/IP protocols and the like.

Further, it should be appreciated that the network 108 may include local area networks (LANs), wide area networks (WANs), direct connections and any combination thereof, as well as other types and numbers of network types. On an interconnected set of LANs or other networks, including those based on differing architectures and protocols, routers, switches, hubs, gateways, bridges, and other intermediate network devices may act as links within and between LANs, WANs and other networks to enable messages and other data to be sent and received between network devices. Also, communication links within and between LANs and other networks typically include twisted wire pair (e.g., Ethernet), coaxial cable, analog telephone lines, mobile cell towers, full or fractional dedicated digital lines including T1, T2, T3, and T4, Integrated Services Digital Networks (ISDNs), Digital Subscriber Lines (DSLs), wireless links including satellite links and other communications technologies.

LAN 104 may comprise one or more private and public networks which provide secured access to the servers 102(1)-102(n). These types of existing standardized messaging schemes used between financial institutions over WANs and LANs is well known and is not described in detail herein.

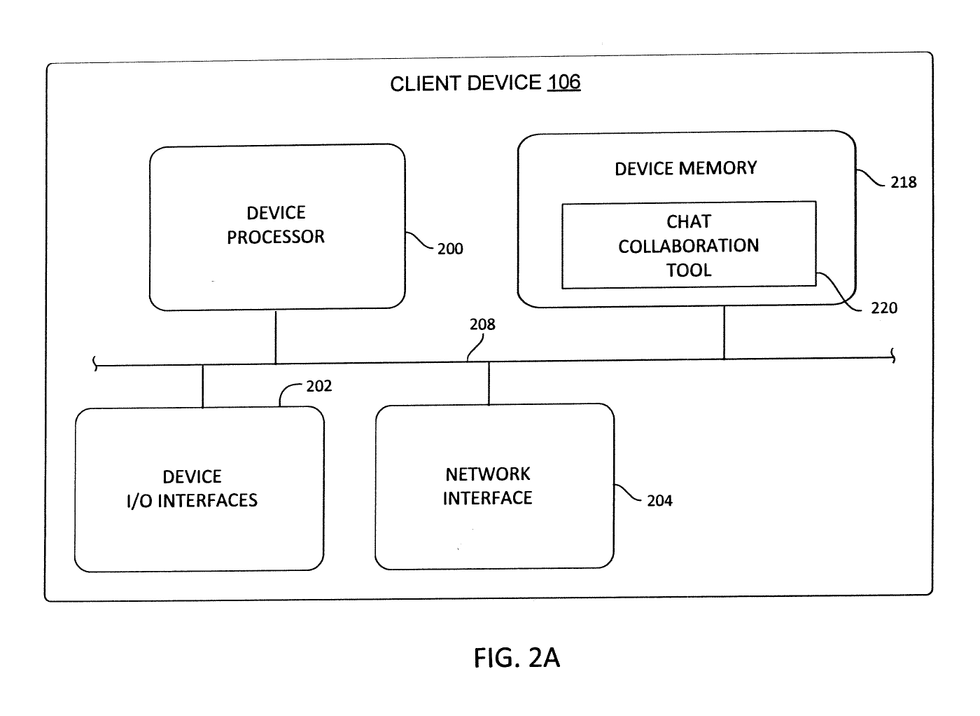

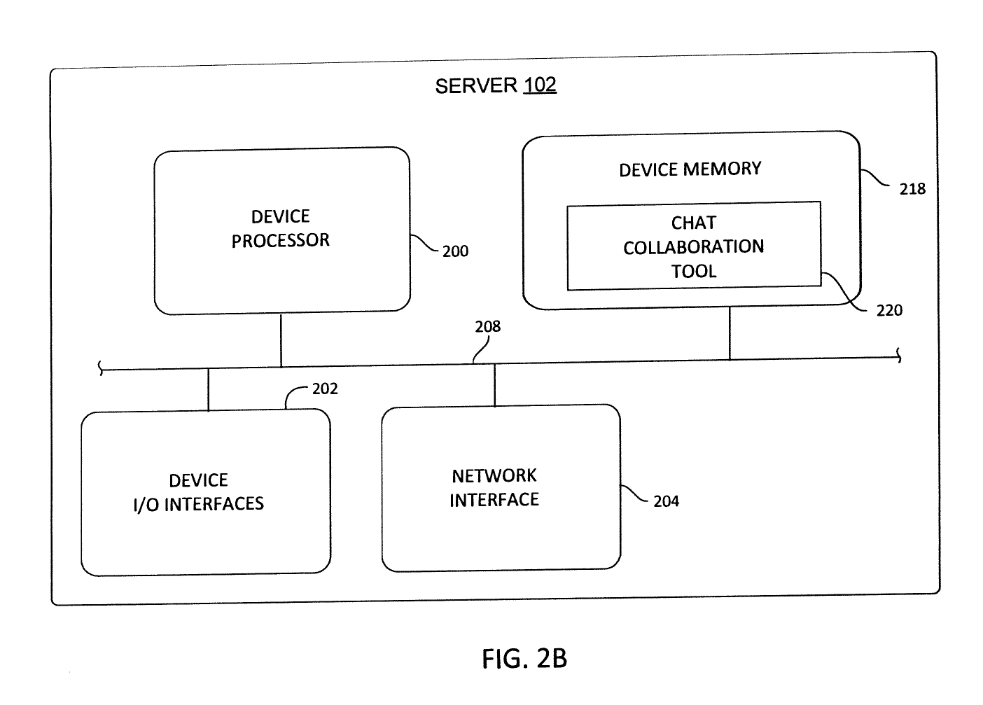

FIG. 2A illustrates a block diagram of a client network device 106 shown in FIG. 1 in accordance with an aspect of the present disclosure. As shown in FIG. 2A, an example client device 106 includes one or more device processors 200, one or more device I/O interfaces 202, one or more network interfaces 204 and one or more device memories 206, all of which are coupled together by one or more buses 208. It should be noted that the device 106 could include other types and numbers of components.

FIG. 2B illustrates a block diagram of a network server device 102 shown in FIG. 1 in accordance with an aspect of the present disclosure. With regard to FIG. 2B, an example server 102 is shown which includes one or more device processors 220, one or more device I/O interfaces 212, one or more network interfaces 214 and one or more device memories 216, all of which are coupled together by one or more buses 218. It should be noted that the server 102 could include other types and numbers of components.

Device processor 200, 210 comprises one or more microprocessors configured to execute computer/machine readable and executable instructions stored in the respective local device memory 206, 216 or in a remote device memory (not shown). Such instructions are implemented by the processor 200, 210 to perform one or more functions described below. It is understood that the processor 200, 210 may comprise other types and/or combinations of processors, such as digital signal processors, micro-controllers, application specific integrated circuits (“ASICs”), programmable logic devices (“PLDs”), field programmable logic devices (“FPLDs”), field programmable gate arrays (“FPGAs”), and the like. The processor 200, 210 is programmed or configured to execute the process in accordance with the teachings as described and illustrated herein of the novel chat collaboration tool and method described below.

Device I/O interfaces 202, 212 comprise one or more user input and output device interface mechanisms. The interface may include a computer keyboard, touchpad, touchscreen, mouse, display device, and the corresponding physical ports and underlying supporting hardware and software to enable communications with other network devices in the system 100. Such communications include, but are not limited to, accepting user data input and providing output information to a user, programming, accessing one or more memory devices and administering one or more functions to be executed by the corresponding device and the like.

In an aspect, network interface 204, 214 comprises one or more mechanisms that enable the client devices 106 to engage in TCP/IP or other communications over the LAN 104 and network 108 with one or more other client devices 106. In another aspect, network interface 204, 214 comprises one or more mechanisms that enable the client devices 106 to engage in TCP/IP or other communications over the LAN 104 and network 108 with one or more server devices 102. However, it is contemplated that the network interface 204, 214 may be constructed for use with other communication protocols and types of networks. Network interface 204, 214 is sometimes referred to as a transceiver, transceiving device, or network interface card (NIC), which transmits and receives network data packets over one or more networks, such as LAN 104 and network 108.

In an example where the client device 106 and/or server 102 includes more than one device processor 200, 210 (or a processor 200, 210 has more than one core), each processor 200, 210 (and/or core) may use the same single network interface 204, 214 or a plurality of network interfaces 204, 214 to communicate with other network devices, such as other client devices 106 and/or server devices 102. Further, the network interface 204, 214 may include one or more physical ports, such as Ethernet ports, to couple its respective device with other network devices in the system 100. Moreover, the network interface 204, 214 may include certain physical ports dedicated to receiving and/or transmitting certain types of network data, such as device management related data for configuring the respective device, and the like.

Bus 208, 218 may comprise one or more internal device component communication buses, links, bridges and supporting components, such as bus controllers and/or arbiters. The bus enable the various components of the device 102, 106, such as the processor 200, 210, device I/O interfaces 202, 212, network interface 204, 214, device memory 206, 216, and chat collaboration tool 220 to communicate with one another. However, it is contemplated that the bus may enable one or more components of its respective device 102, 106 to communicate with components in other devices as well. Example buses include HyperTransport, PCI, PCI Express, InfiniBand, USB, Firewire, Serial ATA (SATA), SCSI, IDE and AGP buses. However, it is contemplated that other types and numbers of buses may be used, whereby the particular types and arrangement of buses will depend on the particular configuration of the device 102, 106 which houses the bus.

Device memory 206, 216 of the client device 106 or server 102 comprises non-transitory computer readable media, namely computer readable or processor readable storage media, which are examples of machine-readable storage media. Computer readable storage/machine-readable storage media may include volatile, nonvolatile, removable, and non-removable media implemented in any method or technology for storage of information. Such storage media stores computer readable/machine-executable instructions, data structures, program modules and components, or other data, which may be obtained and/or executed by one or more processors, such as device processor 200, 210. Such stored instructions allow the processor to perform actions, including implementing an operating system for controlling the general operation of the client device 106 and/or server 102 to perform one or more portions of the chat collaboration tool 220 described below.

Examples of computer readable storage media include RAM, BIOS, ROM, EEPROM, flash/firmware memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Such desired information includes data and/or computer/machine-executable instructions and which can be accessed by the network devices 102, 106.

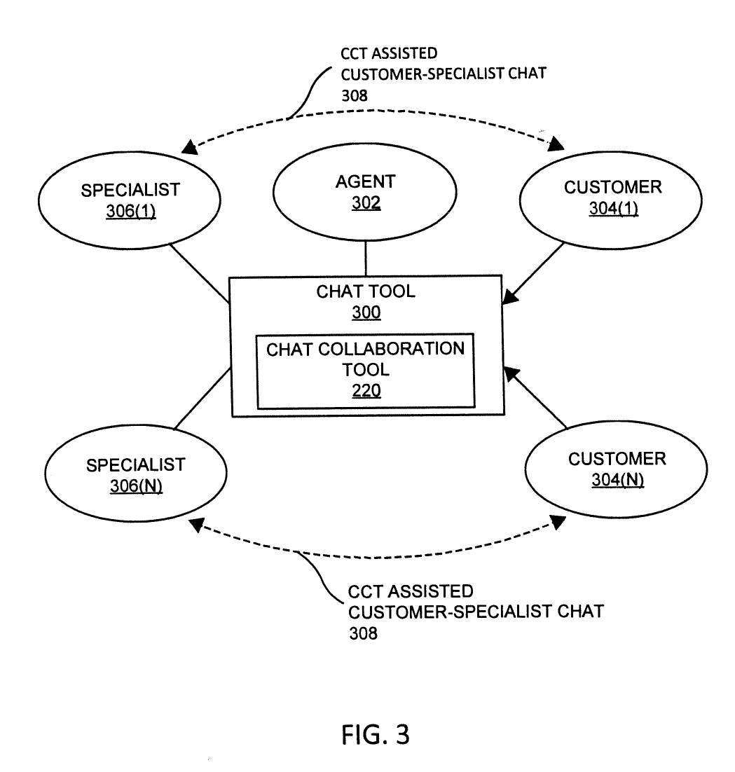

Shown in FIGS. 2A and 2B is the chat collaboration tool 220 which comprises software, which when executed by one or more processors, causes the network device 102, 106 to perform the process described below and shown in FIG. 3. In the aspect, the chat collaboration tool 220 is at least partially executed on a client device 106, and is accessible by the user via a dedicated client software program. In an aspect, the chat collaboration tool 220 is at least partially executed on one or more server devices 102, and is accessible by the user using a client device 106 via a dedicated client software program or a web-browser or mobile application software program. It should be noted that although the chat collaboration tool 220 is shown within memory 206, 216, it may be housed in one or more separate storage devices within or exterior to the network device 102, 106.

In an aspect, the chat collaboration tool 220 is a standalone integrated implementation which is designed to facilitate chat communications between customers and representatives in a company as well as provide the novel dynamic routing method described herein. In an aspect, the chat collaboration tool 220 is an add-on application which can be designed to interface with existing chat communication software designed by the same or other vendor.

FIG. 3 illustrates an example block diagram representing relationships between an agent and a customer and the dynamic routing implementation using the chat collaboration tool between the customer and one or more specialists in accordance with an aspect of the present disclosure. As shown in FIG. 3, the environment 300 includes one or more customer representative chat agents 302, one or more customers 304 and one or more specialists 306. As shown in FIG. 3, the agent 302 utilizes the chat collaboration tool 220 to establish a direct chat session (as shown by lines 308) or a proxied chat session through the agent 302 (as shown by lines 310) between the customers 304 and one or more specialists 306.

A customer issue may involve any technical, billing, sales, service, repair or other matter that a customer has and that the company providing a good and/or service associated with the issue is responsible for handling. In an aspect, the customer issue may be a general or specific question. The customer will typically visit the company's website or mobile software application, whereby the customer is presented with the opportunity to communicate with a company representative via a chat session.

Prior to, or while, establishing a chat session, the customer may provide basic personal information as well as information describing his/her issues that need to be addressed. In an aspect, the customer 304 may provide his/her company account number in which the chat collaboration tool 220 will be able to communicate with one or more databases 110 which may contain specific information about the customer 304. Once the chat session is established between the agent 302 and the customer 304, a session ID, service ticket or other appropriate mechanism will be generated by the chat tool 300 to memorialize and store the details of the session as well as any additional information known about the customer from the company's customer database(s) 110.

While the agent 302 is initially corresponding with the customer 304 via the chat session, the agent 302 may ask the customer specific additional questions regarding the customer's issue(s) to determine if the agent 302 can handle each issue or whether one or more specialists will need to be involved to address the customer's issue(s).

In one scenario, the agent 302 is able to handle, address and/or resolve the customer's issue(s). In particular to this scenario, once the customer's issue is resolved, the chat session is terminated between the agent 302 and the customer 304 without the need for the issue to be escalated to a specialist.

However, if one or more of the customer's issue(s) cannot be handled by the agent 302 and needs to be escalated or handled by one or more specialists 306, the agent 302 utilizes the chat collaboration tool 308 of the present disclosure. In particular, the chat collaboration tool 308 automatically analyzes the customer's issue(s) as well as identifies the customer's specific needs and provides one or more available specialists 306 to further assist the customer. In an aspect, the chat collaboration tool 308 automatically connects the identified specialist(s) to the customer in a direct or proxied chat session for addressing and/or resolving the customer's issue(s). In another aspect, the agent 302 manually connects the customer with the specialist 306, whereby the agent 302 can remain on the chat or not.

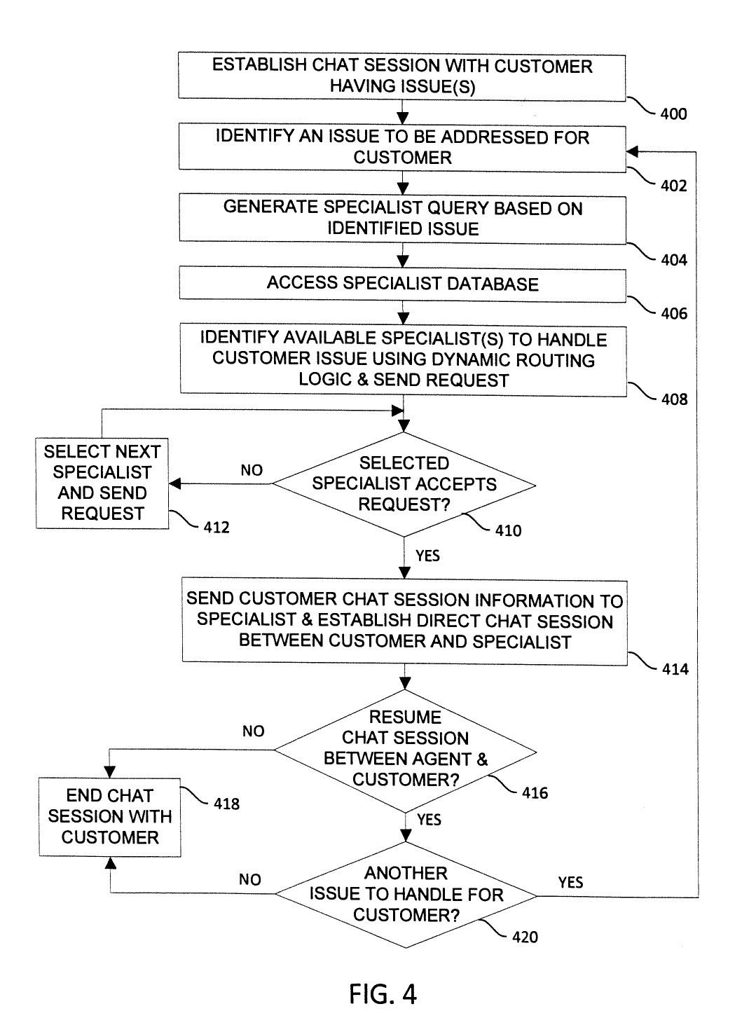

FIG. 4 illustrates a flow diagram representative of a process performed by the chat collaboration tool in accordance with an aspect of the present disclosure. As specified above, the agent receives a customer request and initiates a chat session with the customer who has one or more issues that need to be addressed by one or more customer representatives of the company (Block 400). A chat session between the customer and the agent is established by the chat tool 300 (FIG. 3), whereby a session ID or other mechanism to uniquely identify the chat session is generated. In an aspect, the chat tool 300 stores general and detailed information of the customer, the involved issue(s), query information, identified specialist(s), participating specialist(s), correspondence exchanged in the chat session and the like.

Once the chat session is established between the agent 302 and the customer 304, the agent 302 will be able to review the available information of the customer/issue as well as communicate with the customer to obtain enough information to determine whether s/he will be able to address the issue(s). Any information that the agent 302 receives that is important to the customer's issue is stored by the chat collaboration tool 220 with respect to the customer's session or ticket ID.

In an aspect, if the agent 302 determines that one or more of the customer's issue(s) needs to be escalated, or be handled by a specialist 306, the agent 302 utilizes the chat collaboration tool 220 of the present disclosure. In particular to this aspect, the chat collaboration tool 220 uses gathered information of the customer and/or present/past chat information to identify specifics of the customer's issue(s) that would need to be addressed by the specialist 306 (Block 402).

In identifying the customer's issue(s), the chat collaboration tool 220 analyzes general and specific information of the customer as well as the customer's issue to generate a specialist query (Block 404). In particular, the tool 220 utilizes the generated specialist query to access one or more specialist databases 110 and identify one or more available specialists 306 that would likely be able to successfully handle the customer's issue(s).

The specialist database(s) 110 include one or more data structures, such as look up tables, correlation mapping logic or the like, which contain identification information of a pool of specialists along with each specialist's specific attribute information. The attribute information may include, but not be limited to, the specialist's particular skill set, position title, technical/business experience with respect to identified customer issues, average time to resolve each issue, past customer comments/complaints, geographic time zone, work schedule, number of past successful resolutions by issue, identities of customers that the specialist had previously dealt with (specialist's success rate with that customer), and the like.

In an aspect, the chat collaboration tool 220 in generating the specialist query, includes one or more constraints or parameters specific to the customer's issue using dynamic routing logic. In particular, the dynamic routing logic allows the tool 220, while querying the specialist database 110, to compare the constraints/parameters against the attributes of specialists in the specialist database 110 to find matches and thus narrow down a list of the best potential candidate specialists to handle the issue.

In generating the specialist query, the chat collaboration tool 220 may utilize the customer's account number, geographic location, reward/loyalty account number, customer's personal information or other relevant information about the customer or the issue to aid in identifying a highly matched candidate specialist. In an aspect, the chat collaboration tool 220 may utilize the product order number, warranty number, product model number or other relevant information about the product/service to aid in identifying a highly matched candidate specialist. In an aspect, the chat collaboration tool 220 can query the agent 302 and request additional information about the customer/customer issue(s) to allow so that the chat collaboration tool 220 can be a proper determination of which specialists 306 should be recommended. In an aspect, the chat collaboration tool 220 may be configured to access stored information of previous chat sessions for that particular customer to more effectively identify and select specialists for subsequent chat sessions involving that customer.

As shown in FIG. 4, the chat collaboration tool 220 accesses the specialist database 110 and compares the constraints/parameters of the generated specialist query against the attributes of the specialists within the database using the dynamic routing logic (Block 406). The chat collaboration tool 220 is provided with one or more potential specialists who have some or all attributes that match the constraints/parameters of the search query (Block 408). In an aspect, the chat collaboration tool 220 computes a score for each potential specialist identified in Block 408, whereby the score is computed based on the number of successful matches between the specialist and the constraints/parameters in the query. In an aspect where the tool 220 identifies more than one potential specialist, the tool 220 will suggest one or more candidate specialists who have a higher score with respect to one or more other specialist. The In an aspect, the score is calculated based on a sum value of successful matches between constraints/parameters in the query and corresponding specialist's attributes. It is contemplated, however, that weighted values may be considered or other affinity based algorithms may be used to determine the score.

In an example, the parameters used by the routing logic may indicate that Specialist A has a high proficiency in the customer's issue (e.g. troubleshooting), but Specialist A's work schedule indicates that s/he is not working at the time that the customer's request is received. However, the routing logic may identify Specialist B who is also deemed proficient with the customer's particular issue and has a work schedule that indicates that s/he is currently working when the customer's request is received. The routing logic will thereby automatically identify Specialist B as one of the available specialists to handle the customer's issue.

Returning back to FIG. 4, the agent 302 selects a candidate specialist to handle the customer issue, whereby the chat collaboration tool 220 thereafter sends a request to the selected specialist and waits to receive a response as to whether the selected specialist accepts or denies the request (Block 410).

If the selected specialist denies the request, the chat collaboration tool 220 automatically selects the next candidate specialist in the order and sends a request to the next specialist (Block 412). This process is repeated until the chat collaboration tool 220 receives an acceptance from a selected specialist.

Once the chat collaboration tool 220 receives an acceptance from a selected specialist, the chat collaboration tool 220 sends the stored customer information associated with the chat session between the agent 302 and the customer 304 to the accepting specialist 306. In an aspect, the chat collaboration tool 220 establishes a direct connection between the accepting specialist and the customer such that the customer and specialist can directly communicate with one another in resolving the customer's issue (Block 414).

Once the specialist 306 is able to resolve the customer's issue, the tool 220 allows the specialist to redirect the chat session back to the originating agent 302 if needed (Block 416). If there is no outstanding customer issue to address, the chat session will end (Block 418). In contrast, the chat session with the customer will be relayed back to the agent 302 to handle the outstanding issue (Block 420). If the agent determines that the outstanding issue requires escalation to a specialist, the process goes back to Block 402. Otherwise, the chat session will end (Block 418).

In an example, a customer from San Francisco, Calif. at 9:00 pm PST may contact an agent 302 via a chat tool, whereby the customer's issue is a technical problem with her computer. Further with respect to this example, the customer indicates that her computer displays a “HELLO” on a blue background and cannot be shut down. In this example, the agent 302 escalates the issue and requests the chat collaboration tool 220 to find one or more specialists that can handle the customer's issue. In this example, the chat collaboration tool 220 analyzes the gathered information, such as the issue itself (e.g. “HELLO” on blue background), customer's time zone (e.g. 9 pm PST), customer's hardware type and software type/version and other relevant information. The tool 220 may utilize to identify some proposed sources for the HELLO on blue background issue. For instance, the tool 220 may access a virus definition file and identify that the HELLO on blue background may be attributed to an XYZ virus or ABC virus. In the example, the chat collaboration tool 220 generates a specialist query indicating the above gathered information and accesses the specialist database 110 to find specialists 306 that can handle the problem. The specialist database 110 may contain several specialists 306 who can probably handle the issue, but only two specialists are currently available. The chat collaboration tool 220 displays these available specialists to the agent 302.

In the example, the chat collaboration tool 220, when displaying the results on the agent's 302 user interface, may suggest one specialist over another. In this example, the tool 220 proposes, to the agent 302, specialist A as the first suggested specialist and specialist B as the second suggested specialist. In the example, specialist A may have a higher score based on a higher number of attributes which match the constraints in the specialist query (e.g. specialist A has experience in handling ABC and XYZ viruses). In the example, specialist B may, in contrast, have a lower score based on a lesser number of attributes which match the constraints in the specialist query (e.g. specialist B only has experience in handling the XYZ virus). In the example, agent 302 chooses specialist A, whereby the chat collaboration tool 220 automatically generates a new chat (or proxies the existing chat) session between the customer and specialist A.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A method of utilizing a chat collaboration tool, the method comprising:
establishing, using a network interface, a network enabled chat session between a customer and an agent of an entity, wherein the customer has a customer issue that is to be resolved by a specialist of the entity and not the agent;
generating, using a processor, a specialist query based at least on information of the customer issue, wherein the specialist query includes one or more parameters specific at least to the customer issue;
identifying, using the processor, at least one available specialist capable of handling the customer issue based on a match between an attribute of the available specialist and a corresponding parameter of the specialist query;
displaying the at least one available specialist on a user interface of the agent, wherein the displayed at least one available specialist is configured to be selected by the agent; and
establishing a chat session between the customer and the available specialist upon receiving a selection from the agent via the user interface.

2. The method of claim 1, wherein prior to the step of identifying, the method further comprises:
accessing a database containing information of a plurality of specialists, wherein each specialist includes associated attribute information;
selecting a first parameter of the specialist query and identifying a first plurality of specialists having a corresponding first attribute that satisfies the first parameter;
selecting a second parameter of the specialist query and identifying a second plurality of specialists having a corresponding second attribute that satisfies the second parameter; and
selecting the at least one available specialist, wherein the at least one available specialist has the first and second attributes.

3. The method of claim 2, wherein the at least one available specialist further comprises a plurality of available specialists, the method further comprising:
calculating a first score for a first available specialist;
calculating a second score for a second available specialist, wherein the first score and second score are based on the number of specialists' attributes that satisfy the parameters of the specialist query; and
organizing the first and second available specialists to be displayed to the agent in an order based on their calculated scores.

4. The method of claim 2, wherein the first parameter of the specialist query is a current time of the chat session and the first attribute of a particular specialist indicates that the specialist is available to handle the chat session at the current time.

5. The method of claim 1, wherein the at least one available specialist further comprises a plurality of available specialists, the method further comprising
sending a request to a first available specialist to handle the customer's issue, wherein the chat session remains between the customer and the agent;
receiving a denial from the first available specialist to handle the customer's issue;
sending a request to a second available specialist to handle the customer's issue, wherein the chat session remains between the customer and the agent; and
receiving an acceptance from the second available specialist, wherein the chat session is established between the customer and the second available specialist, the chat session no longer being between the customer and the agent.

6. A computer readable medium having stored thereon instructions for providing a chat collaboration tool, comprising computer executable code which when executed by at least one processor, causes the processor to:
establish, using a network interface, a network enabled chat session between a customer and an agent of an entity, wherein the customer has a customer issue that is to be resolved by a specialist of the entity and not the agent;
generate a specialist query based at least on information of the customer issue, wherein the specialist query includes one or more parameters specific at least to the customer issue;
identify at least one available specialist capable of handling the customer issue based on a match between an attribute of the available specialist and a corresponding parameter of the specialist query;
display the at least one available specialist on a user interface of the agent, wherein the displayed at least one available specialist is configured to be selected by the agent; and
establish a chat session between the customer and the available specialist upon receiving a selection from the agent via the user interface.

7. The computer readable medium of claim 6, wherein the processor, prior to identifying at least one available specialist, is further configured to:
access a database containing information of a plurality of specialists, wherein each specialist includes associated attribute information;
select a first parameter of the specialist query and identify a first plurality of specialists having a corresponding first attribute that satisfies the first parameter;
select a second parameter of the specialist query and identify a second plurality of specialists having a corresponding second attribute that satisfies the second parameter; and
select the at least one available specialist, wherein the at least one available specialist has the first and second attributes.

8. The computer readable medium of claim 7, wherein the at least one available specialist further comprises a plurality of available specialists, the processor further configured to:
calculate a first score for a first available specialist;
calculate a second score for a second available specialist, wherein the first score and second score are based on the number of specialists' attributes that satisfy the parameters of the specialist query; and
organize the first and second available specialists to be displayed to the agent in an order based on their calculated scores.

9. The computer readable medium of claim 7, wherein the first parameter of the specialist query is a current time of the chat session and the first attribute of a particular specialist indicates that the specialist is available to handle the chat session at the current time.

10. The computer readable medium of claim 6, wherein the at least one available specialist further comprises a plurality of available specialists, the processor further configured to:
send a request to a first available specialist to handle the customer's issue, wherein the chat session remains between the customer and the agent;
receive a denial from the first available specialist to handle the customer's issue;
send a request to a second available specialist to handle the customer's issue, wherein the chat session remains between the customer and the agent; and
receive an acceptance from the second available specialist, wherein the chat session is established between the customer and the second available specialist, the chat session no longer being between the customer and the agent.

11. A computing device comprising:
a network interface configured to establish a network enabled chat session between a customer and an agent of an entity, wherein the customer has a customer issue that is to be resolved by a specialist of the entity and not the agent;
a memory having stored thereon instructions for providing a chat collaboration tool, comprising processor executable code;
a processor coupled to the network interface and the memory, the processor configured to execute the processor executable code, the code causing the processor to:
generate a specialist query based at least on information of the customer issue, wherein the specialist query includes one or more parameters specific at least to the customer issue;
identify at least one available specialist capable of handling the customer issue based on a match between an attribute of the available specialist and a corresponding parameter of the specialist query;
display the at least one available specialist on a user interface of the agent, wherein the displayed at least one available specialist is configured to be selected by the agent; and
establish, via the network interface, a chat session between the customer and the available specialist upon receiving a selection from the agent via the user interface.

12. The computing device of claim 11, wherein the processor, prior to identifying at least one available specialist, is further configured to:
access a database containing information of a plurality of specialists, wherein each specialist includes associated attribute information;
select a first parameter of the specialist query and identify a first plurality of specialists having a corresponding first attribute that satisfies the first parameter;
select a second parameter of the specialist query and identify a second plurality of specialists having a corresponding second attribute that satisfies the second parameter; and
select the at least one available specialist, wherein the at least one available specialist has the first and second attributes.

13. The computing device of claim 12, wherein the at least one available specialist further comprises a plurality of available specialists, the processor further configured to:
calculate a first score for a first available specialist;
calculate a second score for a second available specialist,
wherein the first score and second score are based on the number of specialists' attributes that satisfy the parameters of the specialist query; and
organize the first and second available specialists to be displayed to the agent in an order based on their calculated scores.

14. The computing device of claim 12, wherein the first parameter of the specialist query is a current time of the chat session and the first attribute of a particular specialist indicates that the specialist is available to handle the chat session at the current time.

15. The computing device of claim 11, wherein the at least one available specialist further comprises a plurality of available specialists, the processor further configured to:
send a request to a first available specialist to handle the customer's issue, wherein the chat session remains between the customer and the agent;
receive a denial from the first available specialist to handle the customer's issue;
send a request to a second available specialist to handle the customer's issue, wherein the chat session remains between the customer and the agent; and
receive an acceptance from the second available specialist, wherein the chat session is established between the customer and the second available specialist, the chat session no longer being between the customer and the agent.
